(19) United States
(12) Patent Application Publication
(10) Pub. No.: US 2019/0354521 A1
(43) Pub. Date: Nov. 21, 2019

(54) Concurrent Data Processing in a Relational Database Management System Using On-Board and Off-Board Processors

(71) Applicant: Vitesse Data, Inc., Redwood City, CA (US)

(72) Inventors: Feng Tian, Fremont, CA (US); Chong-kwan Tan, Redwood City, CA (US)

(21) Appl. No.: 16/406,521

(22) Filed: May 8, 2019

Related U.S. Application Data
(60) Provisional application No. 62/673,432, filed on May 18, 2018.

(51) Int. Cl. G06F 16/2455; G06F 9/50; G06F 16/25; G06F 9/38

(52) U.S. Cl. CPC G06F 16/2455; G06F 9/3877; G06F 16/25; G06F 9/5027

(57) ABSTRACT

A computer system receives a query for data stored in a relational database management system. The system generates a query plan based on the query, and generates an execution plan based on the query plan. Generating the execution plan includes generating first instructions to a physical resource to execute a portion of the query plan. The computer system determines a first resource cost associated with executing the portion of the query plan using a first CPU and a second resource cost associated with executing the portion of the query plan using a first FPGA of the physical resource. Upon determining that the second resource cost is lower than the first resource cost, the system generates second instructions to the FPGA to execute the portion of the query plan, and executes the execution plan to retrieve the data.

### CROSS-REFERENCE TO RELATED APPLICATION

This application claims priority to U.S. Provisional Application No. 62/673,432, filed May 18, 2018, the entire contents of which are incorporated herein by reference.

### TECHNICAL FIELD

The disclosure relates to computerized data storage systems.

### BACKGROUND

Computers can store, access, and/or modify data using a data storage system, such as a computerized database. As an example, computers can store data within a database, such that the data is recorded and retained for further use. As another example, computers can process, manipulate, or otherwise modify data stored within the database to produce useful or meaningful information from the data. As another example, computers can retrieve a copy of data from the database.

A database is an organized collection of data. In some cases, a database can represent data using a collection of schemas, tables, queries, reports, views, and/or other computer objects.

A database management system (DBMS) is a computer software application that interacts with the user, other applications, and the database itself to capture and analyze data. In some cases, a DBMS can be designed to enable the definition, creation, querying, update, and administration of databases. Example DMBSs include MySQL, PostgreSQL, MongoDB, MariaDB, Microsoft SQL Server, Oracle, Sybase, SAP HANA, MemSQL, SQLite, and IBM DB2.

A relational database management system (RDBMS) is a DBMS that is based on a relational model, or an approximation of a relational model. For instance, data can be represented in terms of tuples, grouped into relations. A database organized in terms of the relational model is a relational database. The relational model provides a declarative method for specifying data and queries. For example, users can directly state what information the database contains and what information they want from it, and let the database management system software take care of describing data structures for storing the data and retrieval procedures for answering queries. Example RMBSs include Oracle, MySQL, Microsoft SQL Server, PostgreSQL, IBM DB2, Microsoft Access, and SQLite.

In some cases, a relational database can use the Structured Query Language (SQL) data definition and query language. In an SQL database schema, a table corresponds to a predicate variable. Further, the contents of a table correspond to a relation. Further still, key constraints, other constraints, and SQL queries correspond to predicates.

### SUMMARY

As described herein, a RDBMS can utilize a variety of different computing resources to perform multiple operations concurrently. As an example, a RDBMS can execute certain operations using on-board processors (e.g., generalized central processing units (CPUs)), and certain other operations using off-board processors (e.g., graphics processing units (GPUs), field-programmable gate arrays (FPGAs), and application-specific integrated circuits (ASICs)). The operations can be dynamically assigned to the computing resources and concurrently executed by these resources, and the results of the operations can be combined to produce a particular output (e.g., to extract queried data from the RMDBS).

In some cases, the RDBMS can selectively and dynamically execute operations using a particular computing resource based on various factors, such as the availability of the computing resource (e.g., whether the computing resource is already being used or is free to be utilized), the effectiveness at which the computing resource can execute a particular operation (e.g., the speed at which the computing resource can execute the operation, the efficiency at which the computing resource can execute the operation, etc.), among other factors. This enables the RDMBS to execute operations more effectively (e.g., more quickly, more efficiently, etc.), and enables the RDBMS to handle a greater number of operations and/or a more complex combination of operations than might otherwise be possible. Further technical benefits are described herein.

In an aspect, a method includes receiving, at a computer system, a query for data stored in a relational database management system. The method also includes generating, using the computer system, a query plan based on the query, and generating, using the computer system, an execution plan based on the query plan. Generating the execution plan includes determining a plurality of available physical resources for executing at least a portion of the query plan, and identifying a first physical resource from among the plurality of available physical resources. The first physical resource includes a first central processing unit (CPU) and a first field-programmable gate array (FPGA). Generating the execution plan also includes generating first instructions to the first physical resource to execute a first portion of the query plan. The method also includes determining a first resource cost associated with executing at least some of the first portion of the query plan using the first CPU and a second resource cost associated with executing at least some of the first portion of the query plan using the first FPGA, and determining that the second resource cost is lower than the first resource cost. In response, second instructions to the first FPGA to execute at some of the first portion of the query plan are generated. The method also includes executing the execution plan to retrieve the data stored in the relational database management system. Executing the execution plan includes transmitting the first instructions to the first physical resource and the second instructions to the first FPGA.

Implementations of this aspect can include one or more of the following features.

In some implementations, generating the execution plan can further include identifying a second physical resource from among the plurality of available physical resources. The second physical resource can include a second CPU and a second FPGA. Generating the execution plan can further include generating third instructions to the second physical resource to execute second portion of the query plan. The method can further include determining a third resource cost associated with executing at least some of the second portion of the query plan using the second CPU and a fourth resource cost associated with executing at least some of the second portion of the query plan using the second FPGA, determining that the fourth resource cost is lower than the third resource cost, and in response, generating fourth instructions to the second FPGA to execute at some of the second portion of the query plan.

In some implementations, the second CPU can be the first CPU. In some implementations, the second CPU can be different than the first CPU.

In some implementations, the second FPGA can be the first FPGA. In some implementations, the second FPGA can be different than the first FPGA.

In some implementations, the second instructions can include a first data portion, and a first code portion. The first code portion can specify operations to be performed by the first FPGA with respect to the first data portion.

In some implementations, the first data portion can be a logical page of data.

In some implementations, the method can include executing the first code portion by the first FPGA. Executing the first code portion can cause the first FPGA to generate a first result based on the first data portion. The method can also include transmitting the first result to the computer system.

In some implementations, the first code portion can correspond to an SQL operation.

Other aspects are directed to systems, devices, and non-transitory, computer-readable mediums for performing the functions described herein.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of a system that stores, retrieves, and modifies data.

FIGS. 2A-2D show an example usage of the system of FIG. 1.

FIG. 3 is a flow chart diagram of an example process for executing a query in an RDBMS.

FIG. 4 is a diagram of an example computer system

### DETAILED DESCRIPTION

A RDBMS can utilize a variety of different computing resources to perform multiple operations concurrently. As an example, a RDBMS can execute certain operations using on-board processors (e.g., generalized CPUs), and certain other operations using off-board processors (e.g., GPUs, FPGAs, and ASICs). The operations can be dynamically assigned to the computing resources and concurrently executed by these resources, and the results of the operations can be combined to produce a particular output (e.g., to extract queried data from the RMDBS).

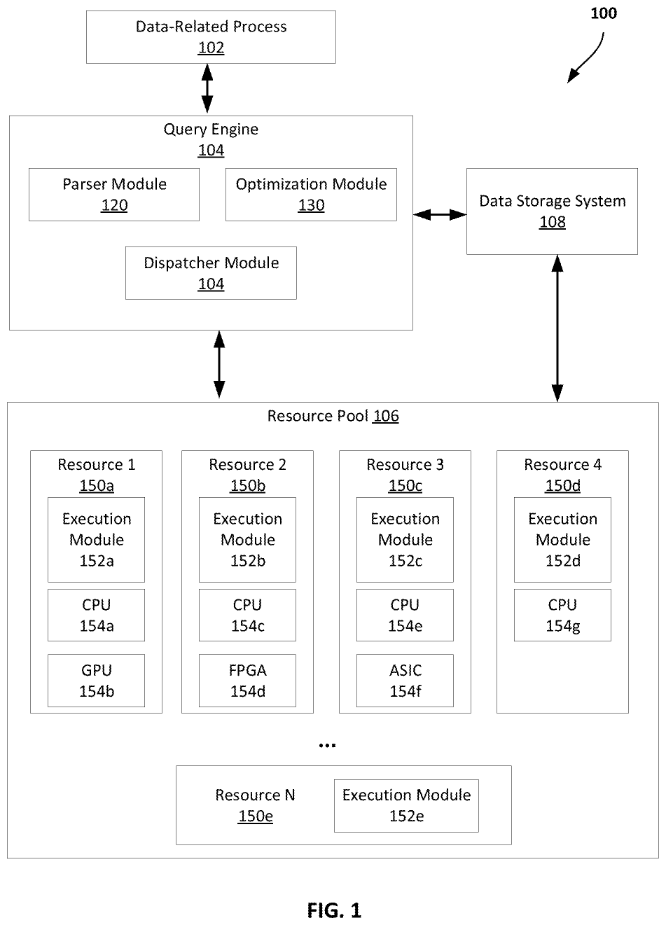

FIG. 1 is a block diagram of a system 100 that stores, retrieves, and modifies data. The system 100 includes one or more data-related processes 102 (e.g., computer programs or portions of computer programs executing on the system), a query engine 104, a resource pool 106, and a data storage system 108.

In an example implementation, a user interacts with the system 100 (e.g., through an appropriate user interface) to create, delete, and modify data. When a user wishes to store particular data (e.g., to retain certain data for later retrieval), a data-related process 102 transmits a storage request with the data to the query engine 104. In turn, the query engine interprets the request, executes the request using the resource pool 106 to store the data on the data storage system 108 (e.g., within one or more physical storage devices or logical units).

As another example, when a user wishes to retrieve particular data, a data-related process 102 transmits a retrieval request for the data to the query engine 104. The query engine 104 interprets the request, executes the request using the resource pool 106 to retrieve the requested data from the data storage system 108, and makes the data available to the data-related process 102.

As another example, when a user wishes to modify particular data, a data-related process 102 transmits a modification request and the modified data to the query engine 104. The query engine 104 interprets the request, executes the request, and executes the request using the resource pool 106 to store modified data on the data storage system 108.

In some cases, the system 100 can be a RDBMS. For example, the system 100 can store data in a relational database (e.g., a database that represents data in terms of tuples, grouped into relations). Further, the data-related processes 102 can be computerized processes that accesses data based on queries (e.g., a portion of code specifying a request for information) represented by code written in a declarative programming language (e.g., SQL).

Various components of the system 100 can be interconnected such that they can each transmit data to and receive data from other interconnected components. For example, some components of the system 100 can be connected such that the data-related processes 102 can communicate with the query engine 104, the query engine 104 can communicate with the resource pool 106 and the data storage system 108, and the resource pool 106 can communicate with the data storage system 108. The interconnection of components can be implemented in a variety of ways. In some implementations, some components can be directly connected to other components, for example through a serial bus connection, system bus, or other direct connection. In some implementations, some components of the system 100 can be interconnected through a local area network (LAN), through a wide area network (WAN), such as the Internet, or through a Storage Area Network (SAN), such as a Fibre Channel network, an iSCSI network, an ATA over an Ethernet network, or a HyperSCSI network. Other types of networks can also be used, for instance a telephone network (cellular and/or wired), a Wi-Fi network, Bluetooth network, near field communications (NFC) network, or other network capable of transmitting data between interconnected systems. In some implementations, two or more networks may be interconnected, such that components connected to one network can communicate with devices connected to another network. In some implementations, some components can be directly connected to other components, for example through a serial bus connection or other direct connection. In some implementations, one or more of the components (e.g., the resource pool 106 and/or the data storage system 108) can be managed by a cloud storage interface. In an example, the resource pool 106 and/or data storage system 108 can be distributed over one or more networks, and the cloud storage interface(s) can manage data-related requests to and from the query engine 104 and/or other communications between any other components.

In some implementations, users can interact with the system 100 through an appropriate user interface to directly or indirectly process data. As examples, the system 100 can be a client computing device, such as a desktop computer, laptop, personal data assistant (PDA), smartphone, tablet computer, or any other computing device that allows a user to view or interact with data. In some implementations, the system 100 does not directly interact with users, and instead indirectly receives instructions and data from users through an intermediary system. As examples, the system 100 can be a computing device such as server computer (or a group of such devices) that indirectly receives instructions and data from users via one or more client computing devices. In some implementations, the system 100 need not receive instructions and data from users at all. For example, in some cases, the system 100 can be automated, such that it creates, deletes, and modifies data without substantial input from a user.

The data-related processes 102 are computerized processes that create, store, access, and/or modify data. As an example, data-related processes 102 can be one or more instances of executable instructions (e.g., a computer program) that perform particular tasks that create, store, access, and/or modify data. Data-related processes 102 can be implemented on various types of components. For example, in some implementations, data-related processes 102 can be implemented on a processing apparatus (e.g., a computer processor) that executes a collection of instructions stored on a data storage device (e.g., memory, a physical storage device, and so forth). When executed, these instructions can perform data processing tasks. In some implementations, data-related processes 102 can be a sub-process of a broader application (e.g., a computer program) that performs additional functions other than creating, storing, accessing, and/or modifying data. As an example, in some implementations, data-related processes 102 can be implemented as a part of an operating system kernel.

The query engine 104 is a component that parses and interprets request from the data-related processes 102, optimizes the request, and dispatches the request to the resource pool 106 to store, access, and/or modify data stored on the data storage system 108. For example, the query engine 104 can receive a request having one or more queries or commands, interpret the commands or queries to ascertain their meaning, optimize the request such that it can be more efficiently and/or effectively executed, and dispatch the request to the resource pool 106 to execute the commands or queries to fulfill the request. The query engine 104 can include various subcomponents, such as a parser module 120, an optimization module 130, and a dispatcher module 140 to perform each of these tasks.

In some cases, the query engine 104 can also manage the storage and retrieval of information in a format that can be readily understood by one or more computer systems. For instance, the query engine 104 can include both a specification of the manner in which data is to be arranged in data storage (e.g., on storage media), and also utilities that enable operations to be performed on the data, e.g., reading and writing of data. As an example, the query engine 104 can include one or more computerized processes or components that control how data is stored and retrieved from one or more data storage systems 108. For instance, a query engine 104 can control how data is stored and retrieved from physical storage devices such as disk accessing storage devices (e.g., hard disk drives), non-volatile random access memory (RAM) devices, volatile RAM devices, flash memory devices, tape drives, memory cards, or any other devices capable of retaining information for future retrieval. As another example, the query engine 104 can include one or more computerized processes or components that control how data is stored and retrieved from one or more logical units of the data storage system 108 (e.g., one or more logical units that have been mapped from one or more physical storage devices or other logical units).

The query engine 104 can parse and optimize a query in a variety of different ways. As an example, a query can be represented by code, and written according to plain text (e.g., including one or more commands written using alphanumeric characteristics and/or symbols). The query engine 104 can parse the code (e.g., using the parser module 120) to determine the presence and relationship between each of the commands represented by the code. As an example, a query can be represented by code written in SQL. Example SQL commands that can be included in an query include SELECT (e.g., to extract data from a database), UPDATE (e.g., to update data in a database), DELETE (e.g., to delete data from a database), JOIN (e.g., to combine rows from two or more tables), INSERT INTO (e.g., to insert new data into a database), CREATE DATABASE, (e.g., to create a new database), ALTER DATABASE (e.g., to modify a database), CREATE TABLE (e.g., to create a new table), ALTER TABLE (e.g., to modify a table), DROP TABLE (e.g., to delete a table), CREATE INDEX (e.g., to create an index or search key), and DROP INDEX (e.g., to delete an index), among others.

The query engine 104 can convert the query into a logical query plan for retrieving the requested data from the system 100. This can be performed for example, using the parser module 120. A logical query plan is a set of information describing one or more relational algebra operations that can be performed to fulfill the query. Example relational algebra operations include union (∪), intersection (∩), difference (−), selection (σ), projection (π), join ( [symbol] ), duplicate elimination (δ), grouping and aggregation (γ), sorting (τ), and rename (ρ), among others.

In some cases, the logical query plan can be represented as a logical tree with two or more interconnected logical nodes, each representing a different relational algebra operation that is performed to fulfill the query.

Further, a logical tree can indicate an order in which different relational algebra operations are performed, and the relational between the input and output of each relational algebra operation. For instance, operations corresponding to the logical nodes can be executed in a tiered manner. For example, operations corresponding to the logical nodes in a lowest tier of the logical tree can be executed first, followed the operations corresponding to the logical nodes in the next higher tier, and so forth until all of the operations have been executed. Further, the output from one operation can be used as an input of another operation, such that data is successively manipulated over multiple different operations. This can be represented, for example, by interconnections between the logical nodes, each representing the exchange of intermediate data between those logical nodes.

In some cases, a logical query plan can be “optimized” for execution. This can be performed, for example, using the optimization module 130. As described herein, a logical query plan is a set of information describing one or more relational algebra operations that can be performed to fulfill the query. Due to the nature of declarative programming languages—which allow users to simply state what information the database contains and what information they want from it, without specifying how such tasks are performed multiple different logical query plans could potentially represent the same query. For example, multiple different logical query plans, which converted into a physical execution plan and executed by the executing engine, might result in the same output, even if the specific steps and order of steps specified in the logical query plan may differ.

To improve the performance of the system, a logical query plan can be optimized, such that use of the logical query plan is faster and/or more efficient. In some cases, the optimization module 130 can generate multiple different candidate logical trees representing a particular query. The optimization module 130 can select one of the candidate logical trees to include in the logical query plan. In some cases, the optimization module 130 can make a selection based on factors or criteria such as a data size of the data stored in the relational database management system, an arrangement of the data stored in the relational database management system, or an estimated resource cost associated with retrieving the data stored in the relational database management system. In some cases, a logical tree can be selected based on an estimated resource cost associated with executing the code written in the programming language that is not native to the execution engine (e.g., the code that is parsed, interpreted, and executed by the transducer).

As an example, there may be many (e.g., millions) of different logical trees, if executed, that all produce the correct answer to a query. Optimization can be performed by choosing one such logical tree that has the minimal (or otherwise acceptably low) execution cost. To choose the tree, an optimization module can compute the estimated cost of executing each of these logical trees.

Statistics and ordering information can be used to compute the cost. Example statistics that can be used include, for example, the number of rows that is input to a particular logical node (e.g., a relational algebra operation), the histogram of input data, and available system resources to the system (e.g., available memory). A system can use this information to compute statistics for the output of the logical node (e.g., the number of rows, the histogram of output data, etc.). This information can be used to optimize other logical nodes that receive inputs from this logical node.

Partition and ordering information can also be useful during the optimization process. For example, if the optimization module knows that the input data is already sorted with respect to values in particular columns, the optimization module may choose an algorithm that takes advantage of this information. For example, if the optimization module knows that data is sorted into groups, aggregates of the data (e.g., sum, average, etc.) within a group can be executed group by group, without having to use a hash table to put data into groups.

Further, the query engine 104 can dispatch the logical query plan request to the resource pool 106 to store, access, and/or modify data stored on the data storage system 108.

The resource pool 106 includes one or more computing resources for executing requests in the system 100. In the example shown in FIG. 1, the resource pool 106 includes N computing resources (e.g., resources 150a-e). Each computing resource 150a-e includes a respective execution module 152a-e, and one or more processors for the execution computer operations (e.g., CPUs, GPUs, FPGAs, ASICs, etc.). For instance, in the example shown in FIG. 1, the computing resource 150a includes a CPU 152a and a GPU 152b, the computing resource 150b includes a CPU 152c and a FPGA 152d, the computing resource 150c includes a GPU 152e and an ASIC 152f, and the computing resource 150d includes a CPU 152g. In some cases, each computing resource of the resource pool 106 can be a different physical resource (e.g., a physical device or system). Although a number of example computing resources are shown in FIG. 1, it is understood that the resource pool 106 can include any number of computing resources (e.g., one, two, three, four, or more). Further, although example computing resources having example combinations of processors are shown in FIG. 1, it is understood that each of the computing resources in the resource pool 106 can include any single processor or any combination of multiple different processors).

A CPU is electronic circuitry within a computer that carries out the instructions of a computer program by performing the basic arithmetic, logical, control and input/output (I/O) operations specified by the instructions. In some cases, a CPU can be a general-purpose computer processor (e.g., a microprocessor having one or more cores for performing generalized computer operations). Example CPUs include Intel Pentium, Xeon, Celeron, Itanium, and Core (e.g., i3, i5, i7, and i9) processors. Other CPUs include Advanced Micro Devices (AMD) K (e.g., K5, K6, K7, K8, K10), Bulldozer, Bobcat, Jaguar and Zen processors. In some cases, each computing resource can include any number of CPUs. In some cases, each computing resource includes at least one CPU.

A GPU is a specialized electronic circuit designed to rapidly manipulate and alter memory to accelerate the creation of images in a frame buffer intended for output to a display device. In some cases, a GPU can have a highly parallel structure that makes them more efficient than general-purpose computer processor for algorithms where the processing of large blocks of data is done in parallel. Example GPUs include GeForce GTX, nVidia Titan X, Radeon HD Radeon r series (e.g., r5, r7, r9 and RX series), nVidia Grid, Radeon Sky, nVidia Quadro, AMD FirePro, Radeon Pro, nVidia Tesla, AMD FireStream, and Radeon Instinct. In some cases, each computing resource can include any number of GPUs. In some cases, one or more computing resources might not include any GPUs.

An FPGA is an integrated circuit that can be configured by a customer or a designer after manufacturing (e.g., “field programmable”). For instance, an FPGA can contain an array of programmable logic blocks, and a hierarchy of reconfigurable interconnects that allow the blocks to be interconnected with one another. Logic blocks can be configured to perform complex combinational functions, or simple logic gates such as AND and XOR. In some cases, logic blocks can also include memory elements, such as flip-flops or more complete blocks of memory. Example FPGAs include FPGAs manufactured by Xilinx, Intel, Micro semi, Lattice Semiconductor, QuickLogic, Atmel, and Achronix, among others. In some cases, each computing resource can include any number of FPGAs. In some cases, one or more computing resources might not include any FPGAs.

An ASIC is an integrated circuit customized for a particular limited use, rather than intended for general-purpose use. For example, a chip designed to run in a digital voice recorder or a high-efficiency cryptocurrency miner can be an ASIC. In some cases, each computing resource can include any number of ASICs. In some cases, one or more computing resources might not include any ASICs.

The resource pool 106 executes logical query plans (or portions of logical query plans) dispatched to it by the query engine 104. As an example, the query engine 104 can parse a query from the data-related process 102, optimize the query into a logical query plan (e.g., using the optimization module 130), and dispatch a portion of the logical query plan (e.g., a “slice” of the logical query plan) or an entirety of the logical query plan to one or more of the computing resources 150a-e in the resource pool 106 for execution. Upon receipt of the dispatched portion of the logical query plan, each computing resource 150a-e executes the dispatched portion of the logical query plan using its respective execution module 150a-e. For instance, each execution module 152a-e selects a processor of the computing resource 150a-e to execute particular operations of the dispatched portion of the logical query plan (e.g., using a single processor of the computing resource 150a-e, or using multiple different processors of the computing resource 150a-e), and transmits instructions to the selected processor to execute those operations. In some cases, a single processor of the computing resource 150a-e can execute all of the operations of the portion of the logical query plan dispatched to the computing resource 150a-e. In some cases, multiple processors of the computing resource 150a-e can be used in conjunction to execute the operations of the portion of the logical query plan dispatched to the computing resource 150a-e (e.g., by executing some of the operations using one processor, while executing other operations using another processor in parallel). The results of the operations are transmitted back to the query engine 104 and/or to the data storage system 108 for storage.

In some cases, executing a portion of the logical query plan can include converting the logical query plan into a physical execution plan for retrieving the requested data from the system 100. This can be performed for example, using one or more execution module of the computing resources. A physical execution plan is a set of information describing how to perform the one or more relational algebra operations used in the logical query plan. In some cases, the physical execution plan can be similar to the logical query plan (e.g., include an arrangement of relational algebra operations in a logical tree), and can additionally include information regarding how data can be provided to each logical node of the logical tree. For example, the physical execution plan can include information describing the location of data to be used as inputs with respect to one or more of the logical nodes (e.g., an access path, a file scan, or an index for the data). As another example, the physical execution plan can include information describing how each operation can be implemented (e.g., a specific computer process, technique, or algorithm to be used to perform the operation). As another example, the physical execution plan can include scheduling information describing the time at which the operations are executed. As another example, the physical execution plan can include scheduling information describing the time at which the operations are executed. As another example, the physical execution plan can specify that certain operations be performed using one or more particular processors (e.g., using one or more CPUs, FPGAs, GPUs, and/or ASICs).

In some cases, an entire query can be dispatched to a single computing resource 150a-e for execution. For example, the query engine 104 can parse a query from the data-related process 102, optimize the query into a logical query plan, and dispatch the entirety of the logical query plan to a single computing resource (e.g., computing resource 150a) for execution.

In some cases, a query can be dispatched to multiple different computing resource 150a-e for execution. For example, the query engine 104 can parse a query from the data-related process 102, optimize the query into a logical query plan, and dispatch different portions of the logical query plan to different computing resources (e.g., different computing resources 150a-e) for execution. This can be beneficial, for example, in balancing the workload between multiple different computing resources (e.g., so that a single computing resource is not overloaded) and/or parallelizing the execution of the query (e.g., to decrease the time needed to execute the query).

Further, in some cases, when a portion of a logical query plan is dispatched to a computing resource 150a-e, the computing resource can execute the entirety of the dispatched portion using a single processor. For example, the query engine 104 can dispatch a portion of a logical query plan to the computing resource 150a for execution. Upon receipt of the dispatched portion, the execution module 152a can generate an execution plan specifying that the entire dispatched portion of the logical query plan be executed using the CPU 154a, and proceed with the execution plan to execute the dispatched portion.

In some cases, when a portion of a logical query plan to dispatched to a computing resource 150a-e, the computing resource can execute different portions of the dispatched portion using multiple different processors. For example, the query engine 104 can dispatch a portion of a logical query plan to the computing resource 150a for execution. Upon receipt of the dispatched portion, the execution module 152a can generate an execution plan specifying that some operations of the logical query plan be executed using the CPU 154a, and other operations of the logical query plan be executed using the GPU 154b. The execution module 152a can them proceed with the execution plan to execute the dispatched portion. This can be beneficial, for example, in balancing the workload between multiple different processors (e.g., so that a single processor of the computing resource is not overloaded) and/or parallelizing the execution of the logical query plan (e.g., to decrease the time needed to execute the operations of the logical query plan). This can also be beneficial, for example, as certain types of processors may be more effective at performing certain types of operations (e.g., certain processors may be capable of performing certain types of operations more quickly or efficiently). Further, by distributing operations in relatively small, discrete portions among several different processors, the latency associated with execution the operations can be reduced this can be beneficial in reducing the latency in performing the operations. Accordingly, particular operations can be dynamically distributed to particularly suitable processors for execution, thereby improving the efficiency and/or speed of operation.

As an example, a logical query plan corresponding to a SQL JOIN function can be dispatched to a computing resource 150a. Execution of the JOIN function may entail execution of several individual operations (e.g., a number of different operations that are collectively performed to produce the result of the JOIN function). Upon receipt of the dispatched portion, the execution module 152a can execute some operations of the JOIN function using the CPU 154a, and other operations of the JOIN function using the GPU 154b.

In some cases, the dispatched portion of the logical query plan can be initially provided to an “on-board” processor (e.g., a CPU) which executes the entire portion of the logical query plan by default. However, at least some of the operations of that logical query plan can be transmitted from the on-board processor to an “off-board” processor (e.g., a CPU, FPGA, or ASIC) for execution (e.g., delegated or scheduled to the off-board processor instead). After execution of the delegated or schedule operation by off-board processor, the results of the operation are transmitted back to the on-board processor (e.g., such that it can be incorporated into results from other operations and/or transmitted to other components of the system 100).

As described herein, operations can be selectively performed on particular computing resources and/or processors of the computing resources to improve the performance of the system 100. In some cases, operations can be dynamically “scheduled” for execution (e.g., queued and dispatched to particular computing resources and/or processors of the computing resources for execution) such that operations are performed in parallel, and in a more effective manner (e.g., more efficiently and/or quickly). For instance, the operations can be scheduled such that multiple operations (e.g., multiple data processing threads) can share the processors of the computing resources in an efficient manner, and execute operations concurrently without interfering with one another.

Further, in some cases, computing resources can be configured to perform operations with respect to “pages” of data atomically (e.g., perform operations with respect to limited, discrete portions of data at a time, each having a pre-determined size). The size of each page (e.g., the amount of data stored in the page) can be pre-selected such that it is sufficiently large so that the fixed resource cost of transmitting the data between an on-board processor (e.g., a CPU) and an off-board processor (e.g., a GPU, FPGA, or ASIC) can be effectively amortized.

For instance, when an on-board processors transmits a page of data to an off-board processors for execution, the on-board processor can copy the page of data from an on-board memory module (e.g., a memory module directly accessible by the on-board processor) to an off-board memory module (e.g., a memory module directly accessible by the off-board processor, such a dedicated memory module for the off-board processor). This can be performed, for example, using an explicit command (e.g., a COPY command), or using other mechanisms provided by the system (e.g., a direct memory access [DMA] operation). The on-board processor can also copy any required parameters for the operation (e.g., parameters specifying the operation to be performed, and the manner in which it is performed).

After the page of data has been copied to the off-board memory module, the off-board processor performs the specified operation on the page of data, and produces a result. The result can be, for example, a byte sequence of data stored on the off-board memory module.

The results of the operation are then copied from the off-board memory module to the on-board memory module, such that it is available to the on-board processor for use. This can be performed, for example, using an explicit command (e.g., a COPY command), or using other mechanisms provided by the system (e.g., a DMA operation).

During this process, the off-board processor performs the operations in an atomic and idempotent manner. For instance, the resources of the off-board processor are wholly committed to the delegated or schedule operations, and cannot be used for other operations (e.g., other tasks cannot be delegated or scheduled for execution on the off-board processor during this time). However, once the operations have been completed and the result has been transferred back to the on-board memory module, the off-board processor is made available for use again, and can be utilized to execute other delegated or scheduled operations.

In some cases, a single processor can be divided into multiple resource groups (e.g., different logical groups), where each group can perform a particular operation in an atomic and idempotent manner, without interfering with any other group. For instance, a single off-board processor can include N resource groups, each configured to execute operations independently of the other groups. Thus, the off-board processor can perform up to N different operations concurrently.

In some cases, operations can be dynamically delegated or scheduled from an on-board processor to an off-board processor if a determination is made that the off-board processor can perform the operation more effectively than the on-board processor (e.g., more quickly and/or more efficiently). This determination can be performed, for instance, by the execution module 152a-e of each computing resource 150a-e.

As an example, if a portion of a logical query plan has been assigned to computing resource, the execution module of that computing resource can determine whether there are any off-board processors that are available to execute at least a portion of the assigned logical query plan. If so, the execution module estimates a resource cost associated with executing certain operations on the on-board processor, and a resource cost associated with executing those same operations on the off-board processor. If resource cost associated with executing those operations on the off-board processor is lower than the resource cost associated with executing those same operations on the on-board processor, the execution module can delegate or schedule those operations for execution on the off-board processor instead of the on-board processor. For instance, the execution engine can pack the necessary data into atomic pages (as described above), and copy the pages and any other associated operation parameters to the off-board memory for use by the off-board processor.

In some cases, the off-board processor can be treated as a co-processor of the on-board processor. For instance, each computing resource can be configured such that the off-board processor logically adds certain “extensions” or additional instructions to the on-board processor, which can be selectively executed to perform operations on the off-board processor. In some cases, these new instructions can include an operation code portion (e.g., indicating the specific operation that is to be performed by the off-board processor), and the data portion (e.g., including the pages of data against which the operations will be performed). The instruction can be transmitted from the off-board processor to the on-board processor for execution (e.g., via a Peripheral Component Interconnect [PCI] computer bus, High Bandwidth Memory [HBM] interface, and/or DMA). The results of the operation can also be returned to the on-board processor using the same interface (e.g., PCI, HBM, and/or DMA).

In some cases, an on-board processor can concurrently perform operations with respect to different processes or threads by “context switching” the processor from one process or thread to another. This enables the on-board processor to isolate different processes or threads from one another, such that they do not interfere with each other. If an operation is delegated or scheduled from the on-board processor to the off-board processor with respect to a particular process or thread, the off-board processor must maintain the same context as the on-board with respect to that process or thread to ensure that the results of the operation are delivered to the correct context of the on-board processor.

As an example, while operating according to a first context, the on-board processor may delegate or schedule a portion of a logical query plan to an off-board processor for execution. After the portion of the logical query plan has been delegated or scheduled, the on-board processor may operate according to a second context to perform other operation. To ensure the data consistency, the on-board processor must switch back to the first context to receive the results of the delegated or scheduled operations from the off-board processor. In some cases, the context switching of the on-board processor can be controlled by the execution engine (e.g., by scheduling and switching the context of the on-board processor to maintain data consistency during operation).

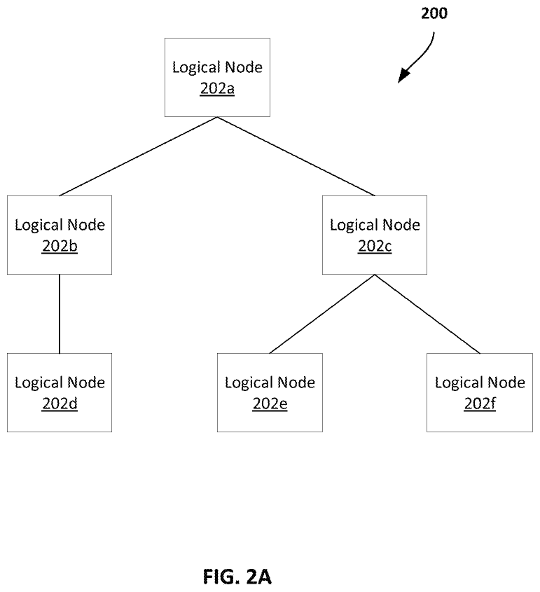

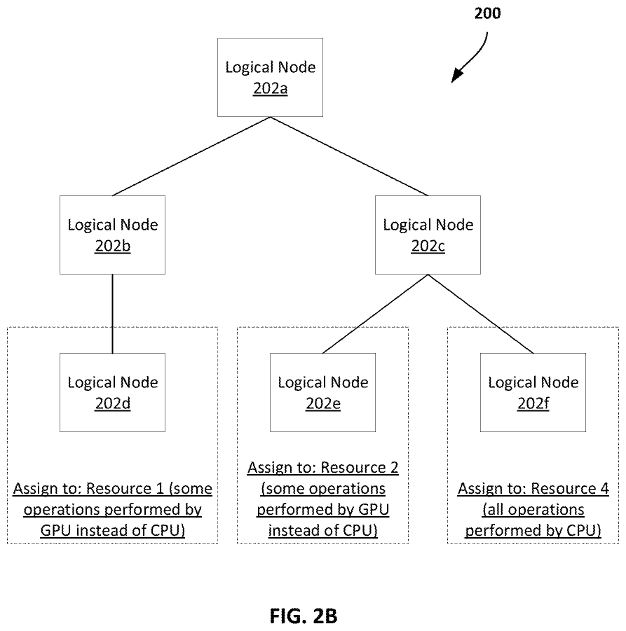

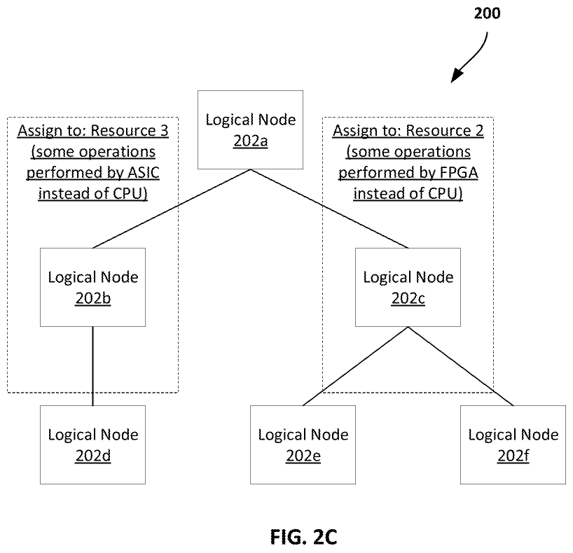

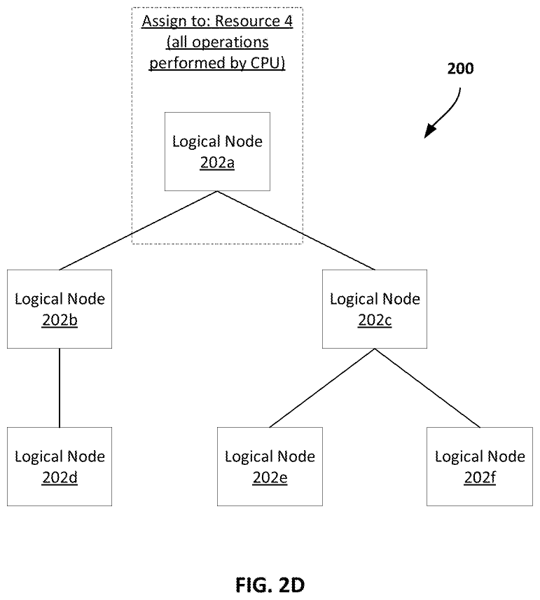

An example usage of the system 100 is shown in FIGS. 2A-2D.

As described above, a data-related process can transmits a request with the data to the query engine 104. In turn, the query engine 104 interprets request from the data-related processes 102 and optimizes the request. For instance, the query engine 104 can convert the query into a logical query plan for retrieving requested data from the system 100.

As an example, as shown in FIG. 2A, a logical tree 200 includes a logical node 202a positioned with respect to a first tier (e.g., a top tier), logical nodes 202b and 202c positioned with respect to a second tier, and logical nodes 202d-f are positioned with respect to a third tier (e.g., a bottom tier). The operations corresponding to each of the logical nodes 202d-f (e.g., in the third tier) are executed first, followed by the operations corresponding to each of the logical nodes 202b and 202c (e.g., in the second tier), followed by the operations corresponding to the logical node 202a (e.g., in the first tier). Further, the output of the logical node 202d is used as an input in the logical node 202b (indicated by a connection line). Similarly, the output of the logical nodes 202e and 202f are used as inputs in the logical node 202c. Similarly, the output of the logical nodes 202b and 202c are used as inputs in the logical node 202a.

The query engine 104 can selectively execute the logical tree 200 using the resource pool 106. For example, the query engine 104 can determine which the computing resources 150a-e of the resource pool 106 are available for utilization, and dispatch portions of the logical tree 200 to particular computing resources 150a-e that are available. For example, as shown in FIG. 2B, the logical query plan can assign execution of the logical node 202d to the first computing resource 150a, execution of logical node 202e to the second computing resource 150b, and execution of the logical node 202f to the fourth computing resource 150d.

Further, each of the operations of each logical node can be executed by an on-board processor of the computing resource (e.g., a CPU) or by an off-board processor of the computing resource (e.g., a GPU, FPGA, or ASIC). For instance, as shown in FIG. 2B, some of the operations of the logical node 202d are performed by the GPU 154b instead of the GPU 154a, and some of the operations of the logical node 202e are performed by the FPGA 154d instead of the CPU 154c. However, in this example, all of the operations of the logical node 202f are performed by the 154g. As described above, operations can be dynamically executed by the off-board processors based on scheduling operations of the execution modules of each computing resource (e.g., by comparing the resource costs associated with executing certain operations using an on-board processor compared to that of an off-board processor).

The results of execution of the logical node 202d are used as inputs to the execution of the logical node 202b, and the results of execution of the logical nodes 202e and 202f are used as inputs to the execution of the logical node 202c. In a similar manner as above, the query engine 104 can selectively execute the next portion of the logical tree 200 using the resource pool 106. For example, the query engine 104 can determine which the computing resources 150a-e of the resource pool 106 are available for utilization, and dispatch the next portions of the logical tree 200 to particular computing resources 150a-e that are available. For example, as shown in FIG. 2C, the logical query plan can assign execution of the logical node 202b to the third computing resource 150c, and execution of logical node 202c to the second computing resource 150b.

Further, as above, each of the operations of each logical node can be executed by an on-board processor of the computing resource (e.g., a CPU) or by an off-board processor of the computing resource (e.g., a GPU, FPGA, or ASIC). For instance, as shown in FIG. 2C, some of the operations of the logical node 202b are performed by the ASIC 154f instead of the CPU 154e, and some of the operations of the logical node 202c are performed by the FPGA 154d instead of the CPU 154c. As described above, operations can be dynamically executed by the off-board processors based on scheduling operations of the execution modules of each computing resource (e.g., by comparing the resource costs associated with executing certain operations using an on-board processor compared to that of an off-board processor).

The results of execution of the logical nodes 202b and 202c are used as inputs to the execution of the logical node 202a. In a similar manner as above, the query engine 104 can selectively execute the next portion of the logical tree 200 using the resource pool 106. For example, the query engine 104 can determine which the computing resources 150a-e of the resource pool 106 are available for utilization, and dispatch the next portions of the logical tree 200 to particular computing resources 150a-e that are available. For example, as shown in FIG. 2D, the logical query plan can assign execution of the logical node 202a to the fourth computing resource 150d. Further, as above, the operations of each logical node can be executed by an on-board processor of the computing resource (e.g., a CPU) or by an off-board processor of the computing resource (e.g., a GPU, FPGA, or ASIC). However, as shown in FIG. 2D, all of the operations of the logical node 202a are performed by the CPU 154g instead of an off-board processor.

Although an example logical tree 200 is shown in FIGS. 2A-2D, it is understood that this is merely an illustrative example. In practice, a logical tree can include any number of logical nodes, arranged according to any number of tiers, and interconnected by any number of different ways. Further, a logical tree can be divided among any number of different computing resources for execution, and can be executed by any combination of on-board processors and off-board processors.

Upon completion of the execution of logical node 202, the result of that execution can be returned to the user and/or stored for later retrieval (e.g., in a data storage system 108).

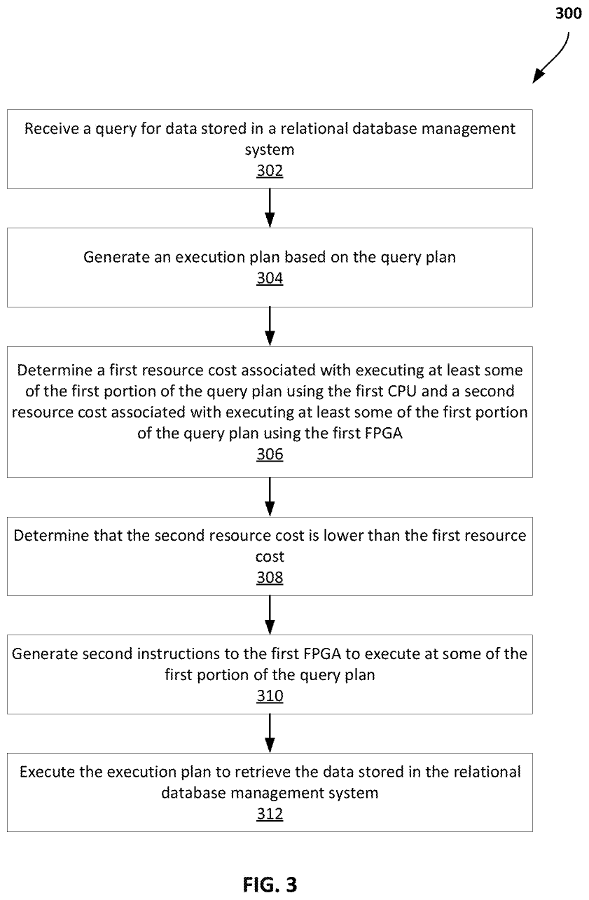

FIG. 3 shows an example process 300 for executing a query in an RDBMS. The process 300 can be performed, for example, using the system 100 to process queries to retrieve data from the system 100.

A computer system receives a query for data stored in an RDBMS (step 302). As an example, referring to FIG. 1, the query engine 104 can be receive a query from a data-related process 102 requesting data stored in the data storage system 108.

The computer system generates a query plan based on the query (step 304). As an example, referring to FIG. 1, the query engine 104 can generate a query plan (e.g., a logical query plan) based on the query.

In some cases, generating the query plan can include determining a plurality of available physical resources for executing at least a portion of the query plan, and identifying a first physical resource from among the plurality of available physical resources. As an example, referring to FIG. 1, a resource pool 106 can include several different computing resources (e.g., physical devices). The query engine 104 can identify a particular computing resource to execute at least a portion of the query plan. Further, the first physical resource can include one or more processors, such as one or more CPUs, GPUs, FPGAs, ASICs, and/or other processors. For instance, the first physical resource can include a first CPU and a first FPGA.

Further, generating the query plan can include generating first instructions to the first physical resource to execute a first portion of the query plan. For instance, referring to FIG. 1, the query engine 104 can generate instructions to one of the computing resources of the resource pool 106 to execute the first portion of the query plan.

Further, the computer system can determine a first resource cost associated with executing at least some of the first portion of the query plan using the first CPU and a second resource cost associated with executing at least some of the first portion of the query plan using the first FPGA (step 306). For instance, referring to FIG. 1, an execution module of one of the computing resources of the resource pool 106 can determine a resource cost associated with certain operations the query plan using a CPU of the computing resource, and a resource cost associated with executing certain operations the query plan using a FPGA of the computing resource. A resource cost can include any expenditure of work associated with executing a portion of the query plan (e.g., a computational cost, a memory cost, a time cost, or any other cost).

A determination is made that the second resource cost is lower than the first resource cost (step 308). In response, the computer system generates second instructions to the first FPGA to execute at some of the first portion of the query plan (step 310). As an example, referring to FIG. 1, an execution module may determine that the resource cost associated with executing certain operations of the query plan using the FPGA of the computing resource is lower than the resource cost associated with executing those operations using the CPU of the computing resource. In response, the execution module can generate instructions to the FPGA to execute those operations.

The execution plan is executed to retrieve the data stored in the relational database management system (step 312). Executing the execution plan includes transmitting the first instructions to the first physical resource and the second instructions to the first FPGA. As an example, referring to FIG. 1, an execution module may transmit instructions to a CPU of a computing resource to perform certain operations, and transmit instructions to a FPGA of the computing resource to perform other operations (e.g., operations in which the FPGA is more suited to perform relative to the CPU).

In some cases, generating the execution plan further can also include identifying a second physical resource from among the plurality of available physical resources. The second physical resource can include a second CPU and a second FPGA. Generating the execution plan can also include generating third instructions to the second physical resource to execute second portion of the query plan. Further, the process 300 can also include determining a third resource cost associated with executing at least some of the second portion of the query plan using the second CPU and a fourth resource cost associated with executing at least some of the second portion of the query plan using the second FPGA, determining that the fourth resource cost is lower than the third resource cost, and in response, generating fourth instructions to the second FPGA to execute at some of the second portion of the query plan. In some cases, the second CPU can be the first CPU (e.g., the same CPU). In some cases, the second CPU can be different than the first CPU (e.g., separate and distinct CPUs). In some cases, the second FPGA can be the first FPGA (e.g., the same FPGA). In some cases, the second FPGA can be different than the first FPGA (e.g., separate and distinct FPGAs).

In some cases, the second instructions can include several different portions. For example, the second instructions can include a first data portion (e.g., containing one or more pages of data), and a first code portion specifying operations to be performed by the first FPGA with respect to the first data portion (e.g., operations to be performed with respect to the one or more pages of data). In some cases, the first data portion can be a logical page of data. In some cases, the process 300 can include executing the first code portion by the first FPGA. Executing the first code portion can cause the first FPGA to generate a first result based on the first data portion. The first result can be transmitted to the computer system (e.g., from the computational resource to the query engine 104).

In some cases, the first code portion can correspond to an SQL operation (e.g., JOIN, SELECT, UPDATE, DELETE, among others).

### Example Technical Benefits

The implementation described herein can provide various technical benefits. For example, as described herein, a RDBMS can utilize a variety of different computing resources to perform multiple operations concurrently. As an example, a RDBMS can execute certain operations using on-board processors (e.g., generalized CPUs) and certain other operations using off-board processors (e.g., GPUs, FPGAs, and ASICs). The operations can be dynamically assigned to the computing resources and concurrently executed by these resources, and the results of the operations can be combined to produce a particular output (e.g., to extract queried data from the RMDBS).

In some cases, the RDBMS can selectively and dynamically execute operations using a particular computing resource based on various factors, such as the availability of the computing resource (e.g., whether the computing resource is already being used or is free to be utilized), the effectiveness at which the computing resource can execute a particular operation (e.g., the speed at which the computing resource can execute the operation, the efficiency at which the computing resource can execute the operation, etc.), among other factors. This enables the RDMBS to execute operations more effectively (e.g., more quickly, more efficiently, etc.), and enables the RDBMS to handle a greater number of operations and/or a more complex combination of operations than might otherwise be possible.

### Example Systems

Some implementations of subject matter and operations described in this specification can be implemented in digital electronic circuitry, or in computer software, firmware, or hardware, including the structures disclosed in this specification and their structural equivalents, or in combinations of one or more of them. For example, in some implementations, the system 100 can be implemented using digital electronic circuitry, or in computer software, firmware, or hardware, or in combinations of one or more of them. In another example, the processes shown in FIGS. 2 and 3 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD-ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

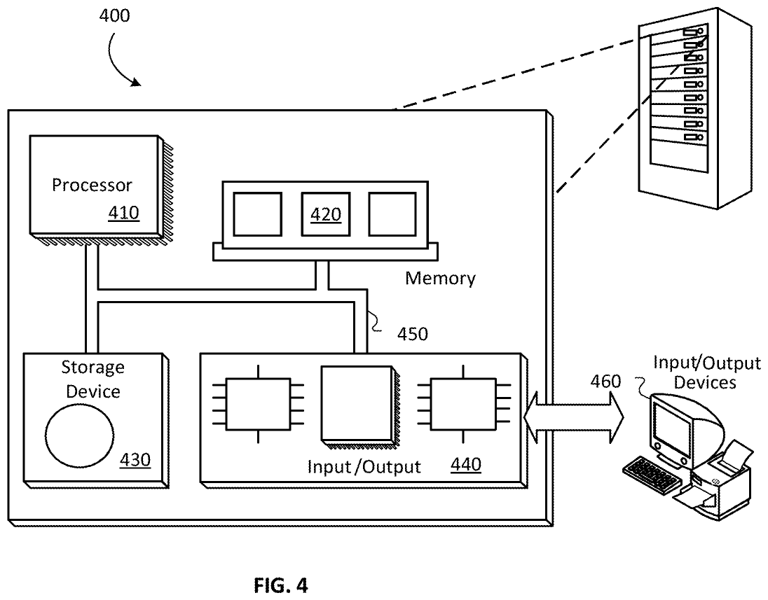

FIG. 4 shows an example computer system 400 that includes a processor 410, a memory 420, a storage device 430 and an input/output device 440. Each of the components 410, 420, 430 and 440 can be interconnected, for example, by a system bus 450. The processor 410 is capable of processing instructions for execution within the system 400. In some implementations, the processor 410 is a single-threaded processor, a multi-threaded processor, or another type of processor. The processor 410 is capable of processing instructions stored in the memory 420 or on the storage device 430. The memory 420 and the storage device 430 can store information within the system 400.

The input/output device 440 provides input/output operations for the system 400. In some implementations, the input/output device 440 can include one or more of a network interface device, e.g., an Ethernet card, a serial communication device, e.g., an RS-232 port, and/or a wireless interface device, e.g., an 802.11 card, a 3G wireless modem, a 4G wireless modem, a 5G wireless modem, etc. In some implementations, the input/output device can include driver devices configured to receive input data and send output data to other input/output devices, e.g., keyboard, printer and display devices 460. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, it will be understood that various modifications may be made without departing from the spirit and scope of the invention. Accordingly, other embodiments are within the scope of the following claims.

What is claimed is:

1. A method comprising:
receiving, at a computer system, a query for data stored in a relational database management system;
generating, using the computer system, a query plan based on the query;
generating, using the computer system, an execution plan based on the query plan, wherein generating the execution plan comprises:
determining a plurality of available physical resources for executing at least a portion of the query plan;
identifying a first physical resource from among the plurality of available physical resources, wherein the first physical resource comprises a first central processing unit (CPU) and a first field-programmable gate array (FPGA);
generating first instructions to the first physical resource to execute a first portion of the query plan;
determining a first resource cost associated with executing at least some of the first portion of the query plan using the first CPU and a second resource cost associated with executing at least some of the first portion of the query plan using the first FPGA;
determining that the second resource cost is lower than the first resource cost; and
in response, generating second instructions to the first FPGA to execute at some of the first portion of the query plan; and
executing the execution plan to retrieve the data stored in the relational database management system, wherein executing the execution plan comprises transmitting the first instructions to the first physical resource and the second instructions to the first FPGA.

2. The method of claim 1, wherein generating the execution plan further comprises:
identifying a second physical resource from among the plurality of available physical resources, wherein the second physical resource comprises a second CPU and a second FPGA;
generating third instructions to the second physical resource to execute second portion of the query plan; and
wherein the method further comprises:
determining a third resource cost associated with executing at least some of the second portion of the query plan using the second CPU and a fourth resource cost associated with executing at least some of the second portion of the query plan using the second FPGA;
determining that the fourth resource cost is lower than the third resource cost; and
in response, generating fourth instructions to the second FPGA to execute at some of the second portion of the query plan.

3. The method of claim 2, wherein the second CPU is the first CPU.

4. The method of claim 2, wherein the second CPU is different than the first CPU.

5. The method of claim 2, wherein the second FPGA is the first FPGA.

6. The method of claim 2, wherein the second FPGA is different than the first FPGA.

7. The method of claim 1, wherein the second instructions comprise:
a first data portion, and
a first code portion, the first code portion specifying operations to be performed by the first FPGA with respect to the first data portion.

8. The method of claim 7, wherein the first data portion is a logical page of data.

9. The method of claim 7, further comprising:
executing the first code portion by the first FPGA, wherein executing the first code portion causes the first FPGA to generate a first result based on the first data portion; and
transmitting the first result to the computer system.

10. The method of claim 7, wherein the first code portion corresponds to an SQL operation.

11. A non-transitory computer-readable medium including one or more sequences of instructions which, when executed by one or more processes, causes:
receiving, at a computer system, a query for data stored in a relational database management system;
generating, using the computer system, a query plan based on the query;
generating, using the computer system, an execution plan based on the query plan, wherein generating the execution plan comprises:
determining a plurality of available physical resources for executing at least a portion of the query plan;
identifying a first physical resource from among the plurality of available physical resources, wherein the first physical resource comprises a first central processing unit (CPU) and a first field-programmable gate array (FPGA);
generating first instructions to the first physical resource to execute a first portion of the query plan;
determining a first resource cost associated with executing at least some of the first portion of the query plan using the first CPU and a second resource cost associated with executing at least some of the first portion of the query plan using the first FPGA;
determining that the second resource cost is lower than the first resource cost; and
in response, generating second instructions to the first FPGA to execute at some of the first portion of the query plan; and
executing the execution plan to retrieve the data stored in the relational database management system, wherein executing the execution plan comprises transmitting the first instructions to the first physical resource and the second instructions to the first FPGA.

12. The non-transitory computer-readable medium of claim 11, wherein generating the execution plan further comprises:
identifying a second physical resource from among the plurality of available physical resources, wherein the second physical resource comprises a second CPU and a second FPGA;
generating third instructions to the second physical resource to execute second portion of the query plan; and
wherein the method further comprises:
determining a third resource cost associated with executing at least some of the second portion of the query plan using the second CPU and a fourth resource cost associated with executing at least some of the second portion of the query plan using the second FPGA;
determining that the fourth resource cost is lower than the third resource cost; and
in response, generating fourth instructions to the second FPGA to execute at some of the second portion of the query plan.

13. The non-transitory computer-readable medium of claim 12, wherein the second CPU is the first CPU.

14. The non-transitory computer-readable medium of claim 12, wherein the second CPU is different than the first CPU.

15. The non-transitory computer-readable medium of claim 12, wherein the second FPGA is the first FPGA.

16. The non-transitory computer-readable medium of claim 12, wherein the second FPGA is different than the first FPGA.

17. The non-transitory computer-readable medium of claim 11, wherein the second instructions comprise:
a first data portion, and
a first code portion, the first code portion specifying operations to be performed by the first FPGA with respect to the first data portion.

18. The non-transitory computer-readable medium of claim 17, wherein the first data portion is a logical page of data.

19. The non-transitory computer-readable medium of claim 17, wherein the one or more sequences of instructions, when executed by one or more processes, causes:
executing the first code portion by the first FPGA, wherein executing the first code portion causes the first FPGA to generate a first result based on the first data portion; and
transmitting the first result to the computer system.

20. The non-transitory computer-readable medium of claim 17, wherein the first code portion corresponds to an SQL operation.

21. A system comprising:
one or more processors; and
a non-transitory computer-readable medium including one or more sequences of instructions which, when executed by the one or more processes, causes:
receiving, at a computer system, a query for data stored in a relational database management system;
generating, using the computer system, a query plan based on the query;
generating, using the computer system, an execution plan based on the query plan, wherein generating the execution plan comprises:
determining a plurality of available physical resources for executing at least a portion of the query plan;
identifying a first physical resource from among the plurality of available physical resources, wherein the first physical resource comprises a first central processing unit (CPU) and a first field-programmable gate array (FPGA);
generating first instructions to the first physical resource to execute a first portion of the query plan;
determining a first resource cost associated with executing at least some of the first portion of the query plan using the first CPU and a second resource cost associated with executing at least some of the first portion of the query plan using the first FPGA;
determining that the second resource cost is lower than the first resource cost; and
in response, generating second instructions to the first FPGA to execute at some of the first portion of the query plan; and
executing the execution plan to retrieve the data stored in the relational database management system, wherein executing the execution plan comprises transmitting the first instructions to the first physical resource and the second instructions to the first FPGA.

22. The system of claim 21, wherein generating the execution plan further comprises:
identifying a second physical resource from among the plurality of available physical resources, wherein the second physical resource comprises a second CPU and a second FPGA;
generating third instructions to the second physical resource to execute second portion of the query plan; and
wherein the method further comprises:
determining a third resource cost associated with executing at least some of the second portion of the query plan using the second CPU and a fourth resource cost associated with executing at least some of the second portion of the query plan using the second FPGA;
determining that the fourth resource cost is lower than the third resource cost; and
in response, generating fourth instructions to the second FPGA to execute at some of the second portion of the query plan.

23. The system of claim 22, wherein the second CPU is the first CPU.

24. The system of claim 22, wherein the second CPU is different than the first CPU.

25. The system of claim 22, wherein the second FPGA is the first FPGA.

26. The system of claim 22, wherein the second FPGA is different than the first FPGA.

27. The system of claim 21, wherein the second instructions comprise:
a first data portion, and
a first code portion, the first code portion specifying operations to be performed by the first FPGA with respect to the first data portion.

28. The system of claim 27, wherein the first data portion is a logical page of data.

29. The system of claim 27, wherein the one or more sequences of instructions, when executed by one or more processes, causes:
executing the first code portion by the first FPGA, wherein executing the first code portion causes the first FPGA to generate a first result based on the first data portion; and
transmitting the first result to the computer system.

30. The system of claim 27, wherein the first code portion corresponds to an SQL operation.
